(19) United States
(12) Patent Application Publication
(10) Pub. No.: US 2024/0092022 A1
(43) Pub. Date: Mar. 21, 2024

(54) CONFIGURATION OF BUILD ENVELOPES

(71) Applicant: HEWLETT-PACKARD DEVELOPMENT COMPANY, L.P., Spring, TX (US)

(72) Inventors: Leticia RUBIO CASTILLO, Sant Cugat del Valles (ES); Sergio GONZALEZ MARTIN, Sant Cugat del Valles (ES); Jaime MACHADO NETO, Sant Cugat del Valles (ES); Alex CARRUESCO LLORENS, Sant Cugat del Valles (ES); Jordi GONZALEZ ROGEL, Sant Cugat del Valles (ES); Yngvar ROSSOW SETHNE, Sant Cugat del Valles (ES); Jordi RAVENTOS CATASUS, Sant Cugat del Valles (ES)

(21) Appl. No.: 17/768,805

(22) PCT Filed: Dec. 20, 2019
(86) PCT No.: PCT/US2019/067977

§ 371 Date: Apr. 13, 2022

(51) Int. Cl. B29C 64/386; B29C 64/40; B33Y 50/00

(52) U.S. Cl. CPC B29C 64/386; B29C 64/40; B33Y 50/00

(57) ABSTRACT

Provided are a system, method and computer program product for generating three dimensional models for use by an additive manufacturing or 3D printing system, in which object model data defining one or more objects to be built by a three-dimensional printing apparatus is input and used to generate a three dimensional model for a protective structure to surround the one or more objects. A user is provided with selectable configuration options for the protective structure. The method includes presenting, via a user interface, selectable configuration options for a protective structure to be built around the one or more objects by the three-dimensional printing apparatus. In response to user selection of one or more configuration options via the user interface, a three dimensional model for the protective structure is automatically generated.

### BACKGROUND

Some additive manufacturing systems, such as powder fusing and powder sintering systems, raise the temperature of a powdered build material to promote fusing or sintering or other bonding. A powdered build material may comprise spheres, granules, pellets, fibres, platelets, particles of irregular shape, hollow particles, and combinations thereof, which can be joined together to form desired objects. In a three-dimensional (3D) printing apparatus that uses raised temperatures during printing, a build operation is followed by cooling of the built objects.

Built objects may be removed from the printing apparatus for cooling, to enable the printing apparatus to be used for other printing jobs while objects are cooling. Printed objects may be cooled within a build unit of a 3D printing apparatus or may be removed from the build unit to complete their cooling. Some 3D printing systems include a build unit that is a removable component of a printing system, so that a build process may be followed by removal of the build unit to a place where it will be cooled. To avoid such movements of build units or removal of objects from a build unit damaging the built objects while they are in a structurally vulnerable state (i.e. when not yet fully cooled), a protective structure forming a surrounding cage or envelope may be built around a printed object or around a set of objects as part of the 3D printing process. The protective structure protects the built objects during cooling, for example by maintaining stability for some layers of unfused build material around fused build material.

### BRIEF DESCRIPTION OF THE DRAWINGS

Apparatus, methods and computer program products are described below, by way of example, with reference to the accompanying drawings in which:

FIG. 1 is a schematic representation of an additive manufacturing system for building 3D objects according to an example;

FIG. 2 shows components of a modelling system according to an example;

FIG. 3 shows an example method of generating a model including model data for a protective build envelope;

FIGS. 4A and 4B show example protective build envelope configurations;

FIG. 5 shows an example build envelope configuration;

FIG. 6 shows an example method of generating a model and building modelled objects;

FIG. 7 shows an example method of generating a model;

FIG. 8 shows an example of a computer readable medium comprising instructions to generate a three dimensional model; and

FIG. 9 shows components of an example printer control architecture.

### DETAILED DESCRIPTION

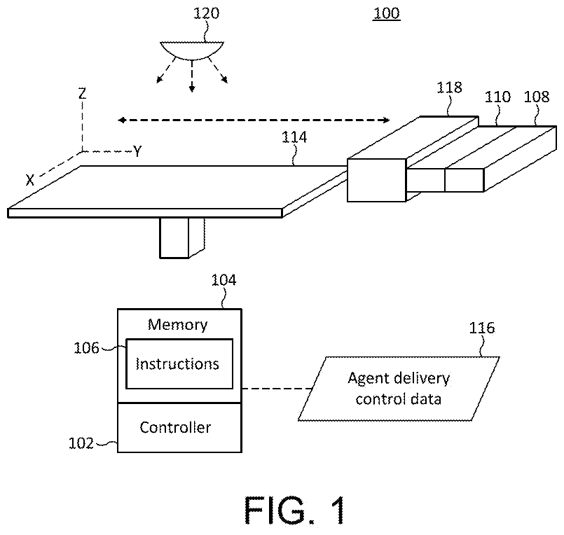

In an additive manufacturing system 100 as shown schematically in a simplified form in FIG. 1, objects may be built layer-by-layer on a build platform 114 within a build chamber (not shown) under the control of a controller 102, by adding successive layers of powdered or granular type of build material and selectively heating portions of each layer to melt and fuse selected parts of each layer before adding the next layer of build material. This may involve fusing together particles of a build powder at specific locations. References to ‘fusing’ herein include sintering, and melting followed by solidification on cooling, and other binding or coalescence mechanisms. The controller 102 may be a microcontroller coupled to a memory 104, for example via a communications bus (not shown). The memory stores executable instructions 106 and can be used to store object model data.

In an example powder distribution and fusing technique that involves selective heating, a set of heaters (not shown) may be used to pre-heat an amount of build material powder in a build unit of an additive manufacturing apparatus to a desired starting temperature that is below the melting point of the build material, and then an energy source 120 is used to irradiate the top layer of build material powder to raise the temperature to a fusing temperature at specified locations only. This can involve selective laser sintering at desired locations, or a fusing technique that applies energy more uniformly but uses an energy absorbing fusing agent to selectively promote fusing at desired locations. In the example of FIG. 1, an additive manufacturing system may include a fusing agent distributor 108 to selectively deliver fusing agent to a layer of build material provided on the support member 114. The system may also include a detailing agent distributor 110 to selectively deliver a fusion-inhibiting agent such as water to the same layer of build material. The agent distributors 108 and 110 may be printheads, such as thermal printheads or piezo inkjet printheads, such as are commonly used in commercially available inkjet printers. The controller 102 controls the selective delivery of fusing agent and detailing agent to the layer of build material in accordance with object model data 116, which may be delivered by a remote agent or integrated data receiver component.

The fused portions become a layer of the object being manufactured, and non-fused portions may be removed at the end of the printing process. The build unit is controlled by a controller that includes a central processing unit and instructions held in a non-transitory storage medium of the printing system. The central processing unit is able to execute computer readable instructions stored in the non-transitory storage medium, to control the physical components of the additive manufacturing system (3D printing system) to build a 3D object in accordance with an object model that is saved to system memory for processing.

Additive manufacturing based on a three-dimensional computer model of an object is often referred to as 3D printing, and the phrases “additive manufacturing” and “3D printing” are used interchangeably in this patent specification. The phrases “additive manufacturing system” and “three dimensional printing apparatus” are also used interchangeably in this patent specification.

One example 3D printing technique is selective laser sintering, in which selected parts of a layer of build material are sintered by the heating effect of a targeted laser beam. Another example 3D printing technique uses energy absorbing fusing agents for highly-localised control of the amount of energy from a radiation source which is absorbed by a build material, to control the temperature of selected parts of a layer of build material according to the presence of a fusing agent (which promotes heat absorption and therefore fusing at selected locations). One example technique using a fusing agent is known as high speed sintering. In some fusing techniques, a detailing agent which has a cooling effect may also be used, to inhibit fusing at chosen locations adjacent to the desired fusing. The example solution described in detail below is suitable for 3D printing techniques including these localised fusing and sintering examples, but the term “fusing” which is used below for ease of reference is intended to include other additive manufacturing techniques that involve heating a powder.

In some 3D printers, an object or a plurality of separate objects may be built by selectively heating, melting and fusing powder particles of a layer of build material on a fabrication bed in a build chamber. The chamber is part of a build unit that is connected to a printing unit which controls the build operation. After the completion of the build operation, the build unit containing the object may be disconnected from the printing unit for cooling, and this may involve connecting the disconnected build unit to an external cooling system. Alternatively, a build unit may be left to cool naturally. To allow the build unit to be available for other build operations, it may be desirable for the built objects to be removed from the build chamber before cooling is complete. In systems using thermal fusing of build material, the built objects may be vulnerable to distortions until they have been cooled below a safe temperature, so there may be a delay before built objects are cold enough to be safely extracted from the build chamber, and there may be a consequent delay before a build unit is connected back to the printing unit to start a new printing process. The cooling of the contents of the build chamber (a printed object or objects and unfused build material) may take a considerable amount of time.

To enable extraction of built objects from the build chamber before cooling is completed following the printing process, a protective structure may be printed around the build objects during the printing of the build objects. The protective structure may be any configuration that provides a degree of protection to the contained objects—e.g. a closed container that fully encapsulates the objects or an open lattice structure that helps to reduce movement of the contained build material and consequently reduces distortion of the built objects. The protective structure may be referred to as a protective “build envelope” or “cage” or “transfer box”, for example, to aid visualization of some potential configurations. The term “transfer box” is intended to refer to any configuration of protective structure that may protect built objects during transfer to a location at which cooling will take pace. The protective structure protects the built objects until they have cooled sufficiently, in particular avoiding damage in examples that allow early extraction when the built objects are in a structurally vulnerable state.

A protective cage or transfer box could be configured in the same way for every build, for example by building a protective cage that surrounds a printable volume and is as large as possible within the constraints of the internal dimensions of the build chamber. In this example, a transfer box may be constructed for any built objects that will be cooled at a different location from the build location, and the transfer box design may be predefined for the dimensions of the particular printer's build chamber, without any adaptation to the particular built objects. However, the present inventors have determined that such a maximum-size transfer box will be non-optimal for many build processes. Firstly, a maximum-size transfer box may use more build material than is optimal; and build material that forms a transfer box is not available for recycling for future print jobs—increasing total manufacturing costs. Secondly, a maximum-size transfer box may encapsulate more layers of unfused build material alongside the fused material of the built 3D objects, resulting in a larger-than-necessary encapsulated mass of fused and unfused build material which takes longer to cool than is optimal.

In the present example, a three dimensional object model for one or more objects (which are to be built within a 3D printing apparatus) may be used to generate a three dimensional model for a protective structure that is adapted to the one or more objects that it is to be built around. The generated model for the protective structure may be based on the dimensions of a minimum size bounding box that contains the one or more objects. For example, a computer model for a set of objects may include an arrangement of the objects so as to fit within a minimum volume while also satisfying a spacing condition (such as a minimum spacing between built objects). A modified three-dimensional model may then be generated, representing the one or more objects and the protective structure model and their positions relative to each other. This modified model data may be used to generate printer control data for a 3D printing apparatus, so that a three-dimensional printing apparatus may build the objects and the protective structure within the same build process. This generation of printer control data may be performed immediately following the generation of the modified object model data, or in some other examples the printer control data may be generated at a point in the future. In some examples the printed data may be generated in the same system that the protective structure model is generated, or in some examples the printer control data may be generated externally.

In an example 3D printer, users are able to specify multiple print jobs in turn, allowing successive manufacturing operations within the same build unit. A first set of one of more objects may be built and protected by a first protective structure, and a second set of objects may be protected by a second protective structure, all within the same 3D printing build unit. The first and second protective structures may have different configurations. Firstly, the first and second sets of built objects may have different outer dimensions such that a transfer box configuration that is optimal for the first set of objects may not be optimal for the second set of objects. Secondly, the first and second sets of printed objects may have different density and/or mass and therefore different cooling times. Thirdly, the first and second sets of objects may have different functional requirements, and these constraints may justify a different cooling speed or different post-processing techniques such as chemical polishing, decaking or dyeing. For example, if a first set of built objects are intended to have high build quality, whereas a second set of built objects are acceptable with a lower build quality, it may be desirable for the first set of objects to be cooled slowly and for the second set of objects to be cooled separately and more quickly. It is possible for the different sets of objects in their respective protective structures to be moved to different locations for slow or fast cooling as required, and so some objects in the same build process can be rapidly cooled even when others should not be. Furthermore, different object dimensions or different functional requirements may justify differences between their protective structures other than the maximum dimensions of the protective structure. For example, some protective structures may comprise an enclosure with solid walls, some protective structures may comprise a cage with side walls having an open configuration, and some protective structures may have a top surface whereas others do not. As another example, some protective structures may be designed with physical connections to the objects—e.g. a connector element may be formed by fusing or sintering some of the build material between a built object and a part of the protective structure—such connections may help to protect the built object during post-print processing.

In each of the above examples, a different configuration of protective structure is optimal for protecting different printed objects. The design of the protective structure may be adapted to the physical parameters and desired functional properties of each object or set of objects being built, and the thermal control of the 3D printing process may also be optimised. This may provide improved performance for 3D printing techniques (such as powder fusion or selective laser sintering techniques) in terms of throughput and part quality, at least in some example solutions.

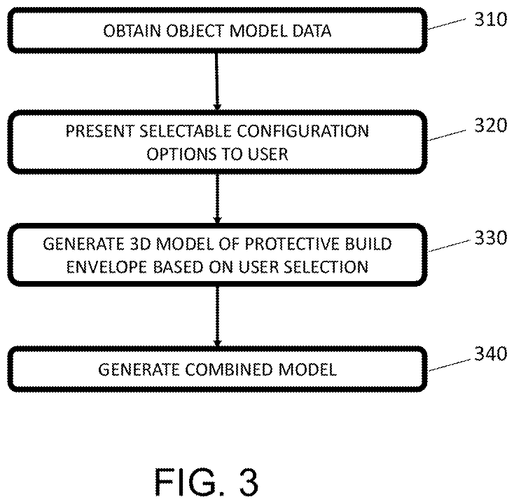

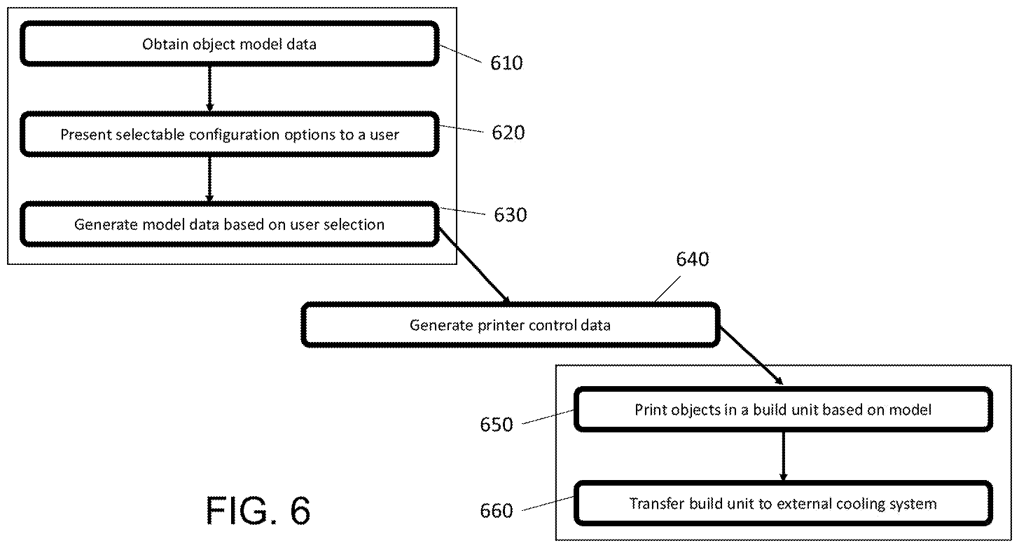

In an example, the three-dimensional model of a protective structure is generated in dependence on the built objects as a pre-printing step which may be carried out remotely from the 3D printing apparatus by a modelling application or a printer job submission application that generates printer control data from a three-dimensional object model. In another example, the three-dimensional model of a protective structure and related printer-specific control data are generated by an integral controller (e.g. a software-controlled processor) of a 3D printing apparatus. In the latter case, new build jobs may be added during building of a first job, so that spare printing capacity is made use of when wanted. FIGS. 3 and 6 show the first of these two examples, in which model generation is shown as a distinct separate pre-processing operation remote from a 3D printer. A printing step may be followed by various post-processing steps.

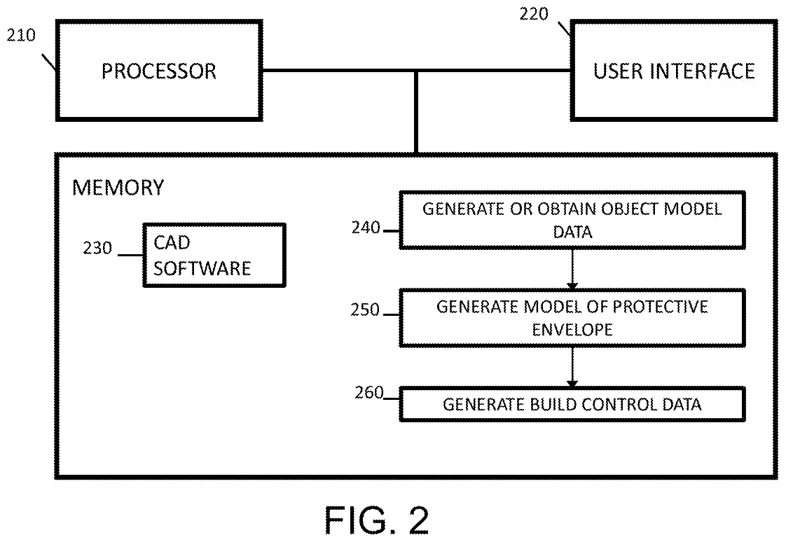

In an example modelling system, shown in FIG. 2, a computer including a processor 210 and running CAD software 230 is used to generate 240 a three dimensional model of an object, and to generate 260 printer control data from the three dimensional models of this and other objects. As well as designing an object's features and dimensions, the example modelling system includes a user interface 220 providing selectable options for a range of requirements and parameters for controlling the printing process. This may be implemented via a user interface exposing options for printing and post-printing operations.

FIG. 3 shows an example method of generating an updated model and FIG. 6 shows an example method of building objects which includes this modelling. In some example methods, an object model may be obtained 310, the object model representing one or more objects to be printed. In response to this object model data, a set of selectable options is provided 320 to a user, for example via a user interface. These selectable options may include various printing and post-printing options and requirements for a build job for the object(s). For example, these options and requirements may include:
an object quality parameter such as dimensional accuracy, which is measurable by dimensional conformance to the three dimensional object model;
a timing parameter, such as a time at which built objects should be available for packaging and delivery; and/or
an “extract” profile which determines whether or not objects should be built with a protective structure, to protect them during a transfer to an external cooling system, when a transfer is desirable for the sake of accelerated cooling or to allow the printing apparatus to restart the build process for new print jobs.
   It should be understood that this list represents an example list of requirements and options, whereas any kind of control of the printing or post-printing procedure may be provided to the user.

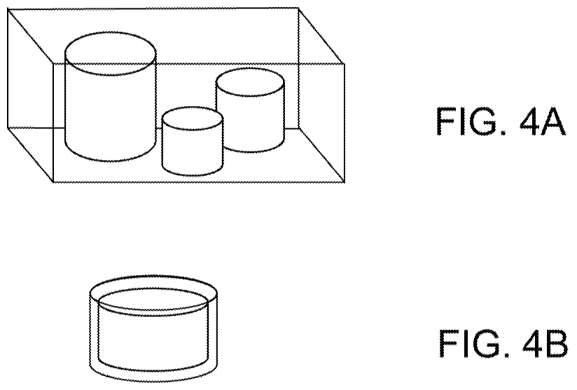

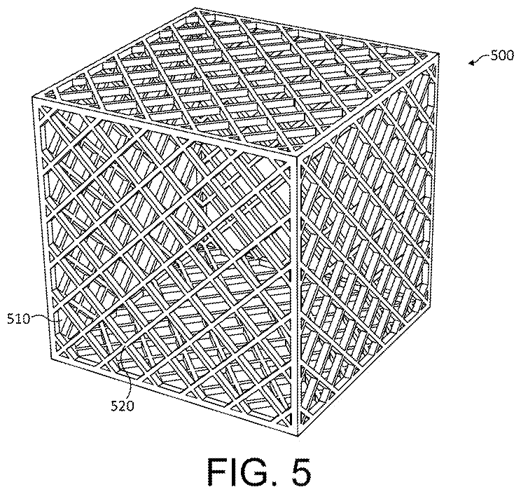

Based on user selection of the options/requirements for the built objects, model build data may be generated 330 representing the object model data and a protective structure based on user selections. For example, generated 3D model data 330 may represent both the objects to be built and a protective structure that was modelled in response to selections by a user, examples of which are provided in FIGS. 4A, 4B and 5. This model data may then be used to generate 640 printer control data, which may be used by a printer unit to print 650 the model in a build unit. After printing of the model, the build unit may be transferred 660 to an external cooling system for cooling of the built model.

As well as selecting whether a build envelope is desired at all, the modelling system user interface according to one example may allow users to make selections that will determine the build envelope configuration. This may involve: obtaining object model data defining one or more objects to be built by a three-dimensional printing apparatus; presenting, via a user interface, selectable configuration options for a protective structure to be built around the one or more objects by the three-dimensional printing apparatus; and, in response to user selection of one or more configuration options via the user interface, automatically generating a three dimensional model for the protective structure.

In the same way that different builds may be submitted to the printer with different printing configurations, when the “extract” profile is selected in the modelling system to specify a desire for external cooling, this implies the generation of a build envelope enclosing the parts comprising the build. The possibility of generating different build envelopes with different properties for each one of the submitted builds is provided and is exposed to the user via selectable options in a user interface.

FIG. 3 shows an example method for generating a protective structure model for one or more objects. This example method may be implemented separately from generation of printer control data that will be used in the build process, as shown in FIG. 6. Object model data is generated 630 for the build envelope, for example by the same pre-print application that is modelling the objects to be built by a printer, or object model data may be obtained 610 from an external application. A number of configuration options may be provided 620 to a user, which may be via a user interface.

For example, the selectable configuration options may comprise one or more of: protective structure dimensions; protective structure geometry; a spacing between the protective structure and the one or more objects; and a thickness or openness of the walls of the protective structure. Each configuration option may have a default value, with some configuration parameters being user-adjustable and other parameters being automatically determined in response to a user selection. This may be exposed to users of a 3D printing system via the system's main user control panel, with selectable options being exposed to users after initiation of a print job; or the selection may be made with external modelling software that is used to generate printer control data for a print job. The latter example is described in more detail below.

In some examples, the following configuration parameters may be modifiable or selectable:
Envelope fitting: the user may select between fitting the envelope to the job parts bounding box (respecting minimum distances—see below), or fitting the envelope to the maximum printable dimensions of the build chamber, or fitting the envelope to the maximum printable dimensions in an XY plane but fit it to the height (Z dimension) of the print job. The latter option allows for a different transfer box to be provided when a new print job is added within the same build unit, and is provided as a default option in the current example unless a user selects another option. Some examples are shown schematically in FIGS. 4A and 4B.

Therefore, a user requiring a smaller envelope to minimize the amount of powder used for its creation can make a positive selection to change from the default setting. This may involve disabling automatic generation of a protective build envelope and using CAD software to design an alternative build envelope. Separation distances: a minimum distance from the build envelope to the printed objects may be selected as a configuration option. Each different material used in 3D printing has a minimum distance that should be maintained to avoid affecting the quality of printed parts, but options may be provided within the constraint imposed by the minimum distance. This may include a distance of each object from the bottom, side and top walls of the envelope. In the current example using a polyamide build material powder PA 12/nylon 12, a minimum distance of 5 mm separation between a printer part and all walls of the build envelope is provided as a default option in the absence of a user selection specifying a smaller distance (e.g. to minimize the amount of unfused material within the envelope) or specifying a larger distance (e.g. to provide more confidence of consistently high part quality). In a printer's user interface, these distances could be modifiable in combination (i.e. all at once) or separately. There could be 1 to 6 parameters for an hexahedral envelope.

Wall thickness: the user may select a wall thickness for each or all of the 6 walls of an hexahedral envelope (1 to 6 parameters). In the current example, 1 mm thickness for all walls is set as a default for solid walls with build material PA12, but different thicknesses are equally possible. In addition to a requirement for the build envelope to remain within the printable area, other thickness limitations may be imposed to ensure that the build envelope has sufficient strength. Higher wall thicknesses may constrain the minimum spacing to be greater, as a thicker walls implies greater absorption of heat energy.

Envelope algorithm generation: the envelope may be selected to have solid walls or an open lattice or grid structure 500 as shown in FIG. 5, and other geometries may be supported. In the current example, the default setting is for each side wall of the protective structure to have an open lattice configuration formed as a grid with rhombus shaped spaces 510 between elements of the lattice 520, for all 6 walls.

If the build envelope side walls have a grid structure, the type and size of the grid element may be defined by a user. This grid element may also be a user-provided binary image, where 1 may mean “fuse” and 0 may mean “do not fuse”. Arbitrary textures may be used to define the grid pattern. In an example, each rhombus of the grid measures 11.4 mm×11.4 mm, with a grid element thickness that is selectable within the range of 1 mm to 2 mm, with a default setting of 1 mm. For a solid wall envelope, the wall thickness can be selected to be less, for example 0.5 mm, and the thickness of the grid lines may be different in the plane of the side wall than in the direction normal to the plane of the side wall A.

A selection of one configuration parameter such as a selection between solid and grid configuration for the protective build envelope walls can influence the valid options for another configuration parameter such as wall thickness.

Enable/disable top and bottom walls: a user may select “open” envelopes, which print 4 side walls without top and bottom walls. The current default is to print all 6 walls, providing improved heat control and part quality. As well as specifying ON/OFF options for top and bottom covers, the thickness of top and bottom covers may each be specified and/or the geometry of these covers. Top covers may be thinner due to not having to support the build and unfused build material, and yet a solid top cover may be selected to preserve dimensional accuracy of the printed parts within the build envelope. If only one job is printed, the default option is for top and bottom covers to both be printed; but if more than one build is printed in the same print bucket, a user may choose to omit top covers of intermediate builds so that build powder (and fusing agents) may be saved. Space within the print bucket may also be saved by omitting intermediate top covers.

Separate top and/or bottom walls: the respective wall may be separated from the build envelope side walls. In the current example, the top wall is a separate component, so that users do not need to cut into the envelope to access the built objects. The modifiable and selectable configuration parameters listed above are provided as an example only. A system for generating three dimensional models and printer control data may support different configuration parameters or parameter values, which could include more or fewer modifiable parameters than listed above.

In addition to providing user flexibility, the modelling system comprises control software that may include computer program code for checking validity of user selections, —i.e. checking configurations are valid for particular materials and object dimensions and previously-selected parameters of a protective build envelope. This can make use of thermal modelling of the built objects and protective build envelope, to predict cooling times taking account of the thermal effects of each object and the envelope itself on each other. For example, the computer program code may configure the computer system to automatically determine, from the obtained object model, valid configuration options such as minimum spacing for a protective structure to be built around the one or more objects by the three-dimensional printing apparatus. The computer system presents a set of valid configuration options for the protective structure, such as an acceptable range of wall thickness and spacing between the protective structure and the objects it contains. In one example, user selection of a first configuration parameter is used by the system to determine valid configuration options for a second configuration parameter. User selection of the second configuration parameter may then be used by the system to determine valid configuration options for a third configuration parameter. In an example, in response to user selection of a first configuration option, the system determines an effect of the user selection on at least one build parameter and presents information about the effect via a user interface, for at least one build parameter. This may be an amount of build material, a cost of build material, a minimum cooling time before removal of built objects from a build chamber of a three dimensional printing apparatus, or a build cost per object. For example, a user-specified requirement for fast cooling may determine the need for a protective build envelope, and a user-specified requirement to control the materials used in the build envelope may limit envelope wall thickness and other dimensions that affect spacing and influence cooling times. Also in response to user selection of a first configuration option, the system may determine a parameter such as an amount of build material for the protective structure, or for a set of protective structures to be printed together, and may provide a user notification based on the calculated amount of build material. The user is able to set certain parameters and the system then generates a suitable model and build process control parameters.

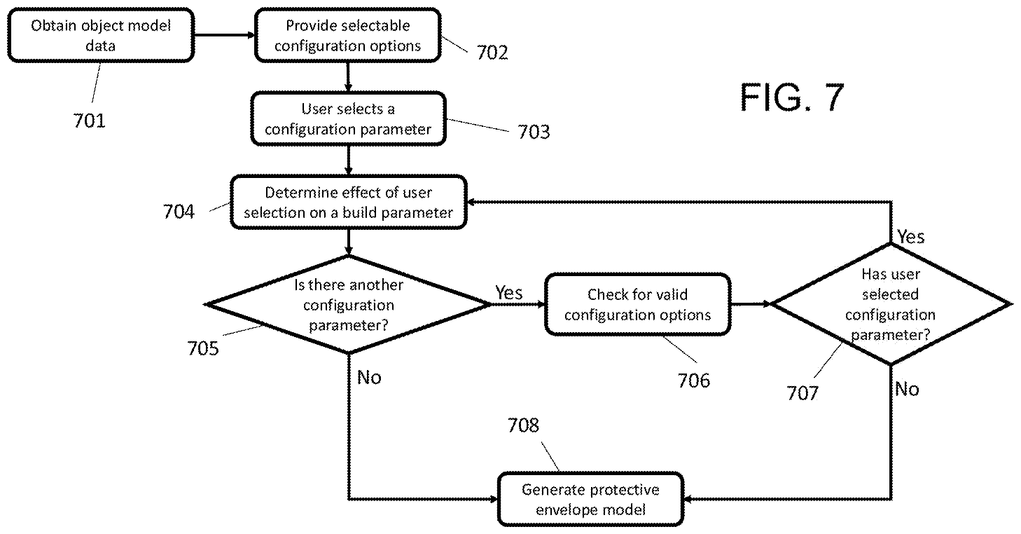

An example processing sequence for the control software is shown in FIG. 7. Object model data is obtained 701, and a first selection option of set of options is determined 702 and presented to the user, who may be an operator of modelling software or an operator of a 3D printer interacting with the control software via a user interface of the printer. The first configuration option may be an option to specify whether rapid external cooling is desired or natural cooling within the 3D printer. This user selection 703 may be processed 704 to determine effects on build parameters, such as determining whether a protective build envelope is desirable (e.g. yes in the case of a need for external cooling; no in the case of natural cooling in situ). If no protective envelope is desired, the process ends. If a protective build envelope is desired, this could lead to fully-automated generation of a 3D model for the protective build envelope, and generation of a combined model for the printable objects and protective envelope. However, in the present example, the first selection prompts a determination 705 of whether there are further configuration options to be exposed to the user for selection. In an example, a positive determination 705 of selectable configuration options is followed by an automated check 706 of valid configuration options. This can include verifying that the defined envelope or envelopes fit in the printable volume of the build unit, and verifying that the system has enough build material and control agent fluids or other resources to complete the build process including building the protective envelopes. A user selection 707 from the valid options is followed by a determination 704 of the effect of the selection on other build parameters. When all choices have been made, a protective envelope model is generated 708.

In one example, the user is invited via a control user interface to sort according to the priority the parameters to optimize: material usage, part quality, cool-down time. Then a set of default optimized parameters are exposed to the user, with an option to fine tune any of them individually.

The modelling system and method of this example may improve the performance of 3D printing systems, such as laser sintering or fusion solutions that heat a build material to at least partially melt and fuse the particles of a build material, by providing an optimal balance between protection and part quality on the one side, and speed of cooling and minimization of costs on the other side. For example, the modelling system and method may improve throughput, part quality and the user experience by giving users the possibility of choosing different build envelope configurations per each one of the builds printed in the same build (i.e. same print bucket and the same printing process). The solution may contribute to improved control of a 3D printing process, since the design of the protective structure may be now adapted to each build geometry. The time between submitting a build to a 3D printer and obtaining the final printed parts ready to be shipped to customers or to be used in final products is a factor that is considered by many users of 3D printing systems. The solution may be implemented to provide 3D printing customers with a lower total cost and a better total cost of ownership (TCO) estimation.

This mechanism enhances and complements systems that allow the possibility of transferring different builds printed together to different cooling units to perform different cooling processes. This may be adapted to the needs of each printed build, with the aim of reducing the time to obtain final parts and thereby optimizing the overall performance of the system.

After the generation of a three-dimensional model and use of the model to generate printer control data or instructions, the modelled objects and protective structures may be built by an additive manufacturing system within a build chamber of the system. The additive manufacturing system may comprise a removable build unit comprising the build chamber, a printing unit comprising an energy source, and control software for controlling the printing unit in accordance with input printer control data. The energy source may be a laser for selective laser sintering of build powder, or a source of radiation may be accompanied by a mechanism for supplying printing control fluids to control the amount of heat absorption to fuse build material at desired locations. An external cooling unit may also be provided.

After building desired objects and a protective structure using a 3D printer, the build unit may be disconnected from the printing unit. At this point, the build unit contains all the 3D printed parts. Once the fused powder of the build unit is cold enough to extract the parts, the build unit may be emptied, loaded with more build material and connected back to the printer to start a new printing process. The cooling of a build inside the build unit takes a considerable amount of time and the unit cannot be used for other purposes during this time. To reduce the impact of this potential inefficiency, a suitable protective build envelope is automatically generated and built around each object or a set of objects, enabling extraction of a hot build from the build unit, soon after the end of the printing process, and enabling transfer of the hot printed parts to an external cooling unit. The automatically generated build envelope reduces the effect of early extraction on part quality of the printed parts.

Another example additive manufacturing system includes a control interface that allows users to submit new builds to the system when it is already printing, if there is enough space left in the print bucket to add the new build. This enablement of ‘build-on-build’ manufacturing may improve the overall performance of the system. If performance optimization is desired, selectability of protective structure configurations may be implemented in a build-on-build environment and external cooling may also be used. It is no longer necessary for all objects printed in the same print bucket during the same printing process to be enclosed in the same protective cage or to be transferred to the same external cooling system. Different build tasks may be added and the objects built within different build envelopes to enable the possibility of transferring each build to a different external cooling unit. Thus, each build may have its cooling time adjusted to the desired characteristics and properties of the objects themselves such as part quality, and adjusted to the other needs of the customer such as timeliness of part availability. Users of a 3D printing system are able to make selections that may help to optimize the performance of the overall object production process, in terms of thermal control and part quality, since the design of each protective build envelope may be optimized per each build geometry.

Once a first job has been submitted to the printer, if the user wants to print another build in the same print bucket than the previous one, there are two options.
The user may add a new build using the same printing configuration and enclose them in the same build envelope as the previous build. In this case, the new build needs to be enclosed by the previously defined and already being printed cage. This is more easily achieved when the build envelope's XY dimensions correspond to the maximum print bucket area, but may also be possible when a build with a large enough bounding box was the first submitted.
The user may stack a new build, enclosed in a new cage, generated according to a new cage configuration. Note that in this case the whole build may be printed using totally different printing settings (different layer thickness, different processing algorithms, etc.).

Once the build is printed, it may be transferred to an external cooling unit while it is still hot, and a plurality of build objects could be transferred to a plurality of cooling systems as each build printed in its own cage may be transferred to a different cooling unit. Two or more builds enclosed into different cages may still be unpacked to the same external cooling unit. Example implementations offer flexibility for users to group parts within the same build envelope according to part quality criteria such as dimensional accuracy and surface finish.

The consumption of build materials for each different cage may be reported to the user via a Web Service or other notification. It may be incorporated in the part completion details once the printing is finished. Thus, users may determine the effect of building the protective build envelope on the final cost of the corresponding build. When only one cage is printed surrounding all the printed builds, the consumption/cost of printing the cage can be equally shared between all the completed builds.

It should be noted that exposing a set of protective structure configuration options to users contrasts with previous attempts to achieve fully automatic building of protective build envelopes. The option for user selection of configuration options may improve the user experience and enable an assessment to be made of the build cost of particular build envelope configurations, allowing this cost to be balanced against the advantages of protecting built objects during a transfer to a cooling system. The user selection also allows the trade-off between part quality and manufacturing speed and cost to be exposed to the user so that an appropriate selection may be made for each build according to functional requirements. A different build envelope configuration may be chosen for each build, even during the same building process, and each build envelope may be transferred to a different active cooling unit or left to cool naturally.

The above description of examples is provided for illustration purposes and is not intended to be limiting on the system or method set out in the accompanying claims. Alternative 3D printing techniques and systems may be used, as well as alternative selectable configuration parameters for a protective structure to be built around a set of one or more printed objects. Many different build materials may be used including, for example, thermoplastic powders. For example, build materials that may be used include semi-crystalline thermoplastic materials with a wide processing window of greater than 5° C. (i.e. the temperature range between the melting point and the re-crystallization temperature). The example mentioned above refers to an example polyamide powder PA12 (which has a melting temperature of 210 degrees C.) as the build material, and a minimum spacing between the build envelope and printed objects of 5 mm. It will be appreciated by a skilled person that many different build materials may be used, such as PA 11/nylon 11 which has a melting temperature of 205 degrees C., or thermal polyurethanes having a melting point ranging from about 100° C. to about 165° C., or the build material may be a liquid, a paste or a gel. Some other example polyamide (PA) build materials include PA 6/nylon 6, PA 8/nylon 8, PA 9/nylon 9, PA 66/nylon 66, PA 612/nylon 612, PA 812/nylon 812, PA 912/nylon 912, etc. Other specific examples of the build material include polyethylene, polyethylene terephthalate (PET), and amorphous variations of these materials. Still other examples of suitable build materials include polystyrene, polyacetals, polypropylene, polycarbonate, polyester, thermal polyurethanes, other engineering plastics, and blends of any two or more of the polymers listed herein. Core shell polymer particles of these materials may also be used. The build material may have a melting point within the range of about 50° C. to about 400° C., and metal or ceramic powder build materials have higher melting temperatures. Depending on the melting point and temperature range between the melting point and re-crystallization temperature, different minimum spacings may be specified between the build envelope and the built objects to avoid adversely affecting printed part quality. These minimum distances may be predefined for a build material and additive manufacturing system, and may be determined by known testing procedures.

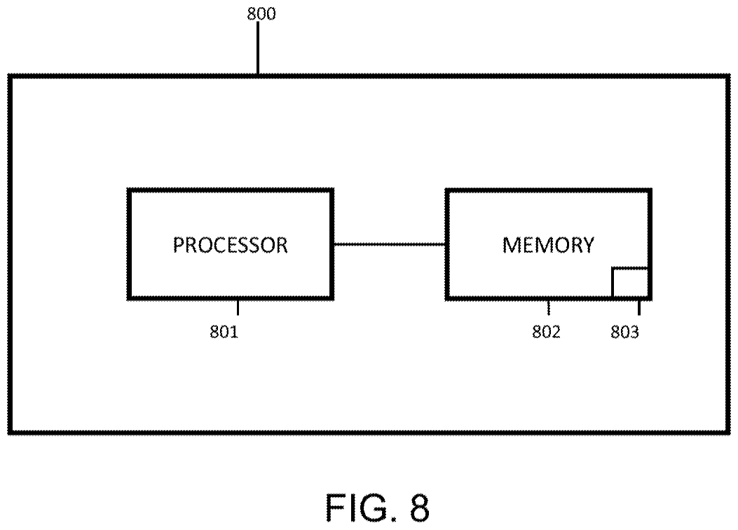

FIG. 8 shows an example of a modelling controller 800 configured to generate model data. The controller 800 comprises a processor 801 and a memory 802. Stored within the memory 802 are instructions 803 for generating a three dimensional model according to any of the examples described above. In one example, the controller 800 may be part of a computer running the instructions 803 as part of a modelling application program remote from an additive manufacturing system that can build objects in accordance with the model data. In another example, the controller 800 may be part of a 3D printer configured to run the instructions 803 after obtaining object model data.

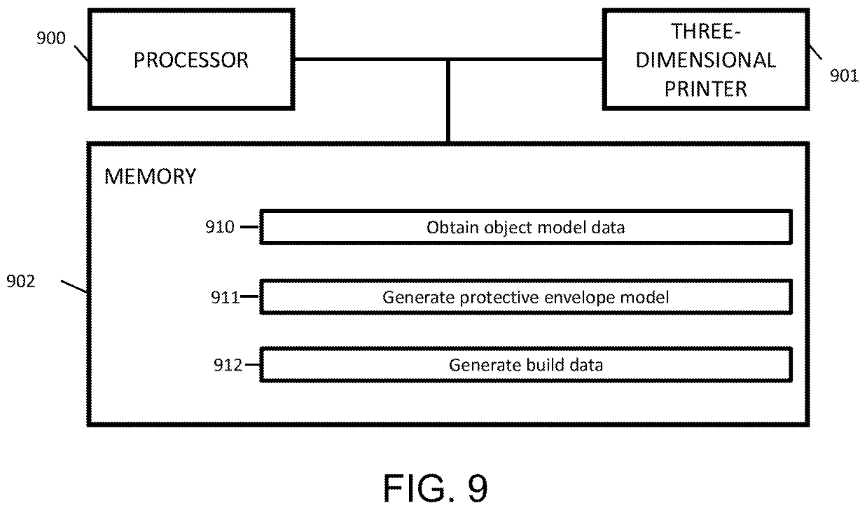

FIG. 9 shows an example control architecture for a 3D printer. A 3D printer 901 is provided with a processor 900 for executing control instructions saved in a memory 902. Memory 902 is an example of a computer readable medium storing instructions 910, 911, 912 that, when executed by the processor 900 communicably coupled to the 3D printer 901, cause the processor 900 to generate model data in accordance with any of the examples described above. The computer readable medium 902 may be any form of storage device capable of storing executable instructions, such as a non-transient computer readable medium, for example Random Access Memory (RAM), Electrically-Erasable Programmable Read-Only Memory (EEPROM), a storage drive, an optical disc, or the like.

1. A method comprising:
obtaining object model data defining one or more objects to be built by a three-dimensional printing apparatus; and
presenting, via a user interface, selectable configuration options for a protective structure to be built around the one or more objects by the three-dimensional printing apparatus; and
in response to user selection of one or more configuration options via the user interface, automatically generating a three-dimensional model for the protective structure.

2. The method of claim 1, wherein the selectable configuration options comprise one or more of: protective structure dimensions; protective structure geometry; protective structure wall characteristics; and spacing between walls of the protective structure and the one or more objects.

3. The method of claim 1, comprising:
automatically determining, from the obtained object model, valid configuration options for a protective structure to be built around the one or more objects by the three-dimensional printing apparatus;
wherein the presenting via a user interface comprises presenting a set of valid configuration options for the protective structure.

4. The method of claim 3, comprising:
in response to user selection of a first configuration parameter, determining configuration options for a second configuration parameter.

5. The method of claim 1, comprising:
in response to user selection of a first configuration option, determining an effect of the user selection on at least one build parameter; and
presenting information about the effect via a user interface.

6. The method of claim 5, wherein the at least one build parameter comprises at least one of: an amount of build material, a cost of build material, a minimum cooling time before removal of built objects from a build chamber of a three dimensional printing apparatus, or a build cost per object.

7. The method of claim 1, comprising:
in response to user selection of a first configuration option, calculating an amount of build material for the protective structure, or for a set of protective structures to be printed together, and providing a user notification based on the calculated amount of build material.

8. The method of claim 1, comprising: generating printer control data comprising instructions to control a three-dimensional printing apparatus to build the one or more objects and to build the protective structure around the one or more objects.

9. The method of claim 8, comprising: controlling a three-dimensional printing apparatus to build the one or more objects and to build the protective structure around the one or more objects.

10. The method of claim 1, comprising:
obtaining object model data defining one or more additional objects to be built by the three-dimensional printing apparatus; and
presenting, via a user interface, selectable configuration options for an additional protective structure to be built around the one or more additional objects by the three-dimensional printing apparatus; and
in response to user selection of one or more configuration options via the user interface, automatically generating a three dimensional model for the additional protective structure, wherein the respective models for the protective structure and additional protective structure are each determined by respective user selections.

11. A system comprising:
a controller configured to:
obtain object model data defining one or more objects to be generated by an additive manufacturing system;
display, via a user interface, selectable configuration options for a protective structure to be built around the one or more objects by the additive manufacturing system; and
generate a three-dimensional model for the protective structure to be built around the one or more objects by the additive manufacturing system, wherein the three dimensional model for the protective structure is generated in dependence on user selection of one or more configuration options via the user interface.

12. The system of claim 11, comprising a computer-implemented modelling system for generating printer control data, the printer control data comprising instructions to control a three-dimensional printing apparatus to build the one or more objects and to build the protective structure around the one or more objects.

13. The system of claim 11, comprising an additive manufacturing system including:
a user interface for selecting configuration options for a protective structure to be built around the one or more objects by the additive manufacturing system; and
a build unit for building the one or more objects and the protective structure.

14. The system of claim 11, wherein the controller is configured to automatically determine, from the obtained object model, valid configuration options for a protective structure to be built around the one or more objects by the three-dimensional printing apparatus, and wherein the controller is configured to present a set of valid configuration options via the user interface.

15. A computer-readable medium comprising instructions that, when executed by a processor communicably coupled to an additive manufacturing system, cause the processor to:
obtain object model data defining one or more objects to be built by the additive manufacturing system;
determine configuration parameters for a protective structure to be built around the one or more objects by the additive manufacturing system, based on the obtained object model for the one or more objects and one or more configuration options for the protective structure selected via a user interface; and
generating printer control data comprising build data to control the additive manufacturing system to build the one or more objects and the protective structure in accordance with the obtained object model and the determined configuration parameters.
